(19) United States
(12) Patent Application Publication
(10) Pub. No.: US 2009/0002770 A1
(43) Pub. Date: Jan. 1, 2009

(54) HOST-ASSISTED WEB PAGE PRINTING FROM MOBILE DEVICES

(76) Inventors: Barry Richard Cavill, Versailles, KY (US); William Henry Reed, Lexington, KY (US); Maini Helena Williams, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/769,062

(22) Filed: Jun. 27, 2007

(51) Int. Cl. H04N 1/00

(52) U.S. Cl. 358/402

(57) ABSTRACT

A system and method for performing host-assisted web page printing from a mobile device is disclosed. A direct communication link is established with the mobile device and one or more files associated with a web page are received from the mobile device. The one or more files associated with the web page are transferred to a host and processed by a print application program running on the host to generate print data corresponding to the one or more files. The print data is processed through a printer driver and printed.

### CROSS REFERENCE TO RELATED APPLICATION

The present application relates to co-pending U.S. application Ser. No. 11/609,008, filed Dec. 11, 2006, entitled “Host-Assisted Document Printing from Mobile Devices,” the disclosure of which is incorporated by reference herein in its entirety.

### FIELD OF THE INVENTION

The present invention relates to printing, and, more particularly, to host-assisted web page printing from a mobile device.

### BACKGROUND OF THE INVENTION

High speed data support (i.e., G3 or third generation services) for mobile phones and other mobile information devices allows the downloading of documents and web pages from network servers and the Internet. With such devices, people can conveniently access vast amounts of information almost anywhere and anytime without carrying a heavy computer with them. However, such documents and web pages typically display poorly on the small screens of the mobile devices.

Internet web pages are typically formatted and stored using a HyperText Markup Language (HTML). The HTML specification of some web pages has been further defined according to the rules of an Extensible HyperText Markup Language (XHTML). XHTML is a more robust format that requires more discipline and structure in writing web page files. Several different versions of HTML and XHTML are typically in use on the Internet at any given time. Typical web browsers utilized on personal computers are generally able to read, display, and print web pages that are formatted according to a wide variety of different HTML and/or XHTML versions. Mobile devices, however, are generally more proprietary and lack the system support for printing web pages that is typically present in a personal computer.

For competitive reasons like increased cost and decreased battery life, mobile device vendors currently do not have or wish to include the capability to support the processing of many different web page formats for printing. Some mobile devices are capable of supporting a subset of web pages for printing. For example, some mobile device vendors have adopted standards for defining a subset of XHTML files that can be processed for printing by a mobile device. These standards include the Bluetooth SIG in the Basic Print Profile (BPP), the UPnP Forum in Print Enhanced, and the Mobile Imaging and Printing Consortium (MIPC) Design Guidelines. However, there are a large number of web pages that do not fall within any of these standards.

Given the growing number of mobile phones and other mobile information devices that now include access to data over the Internet, there is an increased demand for direct printing of web pages that are accessed with these mobile devices. Standardized connections exist to connect these mobile devices to a printer; however, the majority of personal printers are low-cost devices incapable of standalone processing of web page files for printing.

Accordingly, there is a need for an improved system and method for printing web pages from mobile devices.

### SUMMARY OF THE INVENTION

According to one embodiment of the invention, there is provided a method for performing host-assisted web page printing from a mobile device. A direct communication link may be established between the mobile device and a printer and one or more files associated with a web page may be transferred from the mobile device to the printer. The printer may send the one or more files to a host, and a print application program running on the host may process the one or more files to generate print data corresponding to the web page. The print data may be processed through a printer driver associated with the printer, and the print data may be printed at the printer.

According to another embodiment of the invention, there is provided a system for performing host-assisted web page printing from a mobile device. The system may include a mobile device, a printer and a host. The mobile device may be configured to download one or more files associated with a web page and to transfer the one or more files to a printer via a direct communication link formed between the mobile device and the printer. The printer may be configured to receive the one or more files from the mobile device, to transfer the one or more files to the host, to receive print data associated with the one or more files from a printer driver associated with the printer, and to print the print data. The host may be configured to receive the one or more files from the printer, to process the one or more files with a print application program to generate print data corresponding to the web page, to direct to processing of the print data through the printer driver associated with the printer.

Aspects of the invention described below may apply to both the method for performing host-assisted web page printing from a mobile device and to the system for performing host-assisted web page printing from a mobile device. According to one aspect of the invention, one or more additional files associated with the web page that are needed in order to generate the print data may be identified. The one or more additional files may be identified by the mobile device and transferred from the mobile device to the printer. Alternatively, the one or more additional files may be identified by one of the printer and the host. According to an aspect of the invention, if the one or more additional files are identified by one of the printer and the host, a request for the one or more additional files may be communicated to the mobile device, and the one or more additional files may be transferred from the mobile device to the printer. Alternatively, the one or more additional files may be downloaded from a network by the host. According to an aspect of the invention, the one or more additional files may be processed by the print application program to generate the print data.

According to another aspect of the invention, the printer driver may be resident in one of the host and the printer. According to yet another aspect of the invention, the direct communication link from the mobile device to the printer is a wireless connection using a wireless communication standard. Alternatively, the direct communication link from the mobile device to the printer is a wired connection using a wired communication standard.

According to yet another aspect of the invention, the mobile device may initiate service discovery to identify each web page file type that the printer is configured to receive from the mobile device. According to another aspect of the invention, the printer may initiate service discovery to identify each web page file type that the host is configured to receive and process. The results of the service discovery initiated by the printer may be communicated to the mobile device. According to an aspect of the invention, if the service discovery indicates that the printer is configured to receive a web page file type available from the mobile device, the mobile device may initiating the transferring of the one or more files associated with the web page from the mobile device to the printer. According to yet another aspect of the invention, the service discovery may include identifying each web page file type that each printer of a plurality of printers is configured to receive. A particular printer may be selected from the plurality of printers for receiving the one or more files associated with the web page. According to another aspect of the invention, the host may be one of a plurality of hosts communicatively coupled to the printer, the host being selected by the printer as having a capability to process the one or more files associated with the web page.

According to another aspect of the invention, the mobile device may initiate print settings to be used in the creation of printed output at the printer. According to yet another aspect of the invention, the one or more files associated with the web page may be formatted according to a HyperText Markup Language (HTML). According to another aspect of the invention, the printing may be initiated by the mobile device, and the method or system may operate without a user of the mobile device being informed of the processing steps performed by the host.

Other embodiments, objects, features and advantages of the invention will become apparent to those skilled in the art from the detailed description, the accompanying drawings and the appended claims.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of an imaging system, according to an illustrative embodiment of the invention.

FIG. 2 is a block diagram of a control unit that may be utilized by the imaging system of FIG. 1, according to an illustrative embodiment of the invention.

FIG. 3 is an exemplary flowchart of a method for performing host-assisted web page printing from a mobile device, according to an illustrative embodiment of the invention.

FIG. 4 is a block diagram of a second illustrative embodiment of an imaging system embodying the invention.

FIG. 5 is a block diagram of a third illustrative embodiment of an imaging system embodying the invention.

FIG. 6 is an exemplary flowchart of alternative steps for use in conjunction with the method of FIG. 3 in accordance with the embodiment of FIG. 6.

FIG. 7 is a block diagram of a fourth illustrative embodiment of an imaging system embodying the invention.

FIG. 8 is an exemplary flowchart of alternative steps for use in conjunction with the method of FIG. 3 in accordance with the embodiment of FIG. 7.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF EMBODIMENTS OF THE INVENTION

Embodiments of the present inventions will now be described more fully hereinafter with reference to the accompanying drawings. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention are described below with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by special purpose hardware-based computer systems that perform the specified functions or steps, or combinations of special purpose hardware and computer instructions.

Disclosed are systems and methods for host-assisted web page printing from mobile devices. According to an embodiment of the invention, one or more files associated with a web page may be accessed and downloaded to a mobile device. In order to print the one or more files, a direct communications link may be established between the mobile device and a printer, and the one or more files may be transferred or communicated to the printer. The printer may transfer or communicate the one or more files to a host for processing. The host may process the one or more files and generate print data associated with the web page. The print data may be processed through a printer driver associated with the printer and printed by the printer.

For purposes of the present disclosure, it will be appreciated that a web page may consists of one or more files and/or objects that are referenced by the web page. The printing of a web page may require that these one or more files be processed and/or reassembled into a format that resembles that which is displayed on a network when the web page is accessed. Because a web page may consists of more than one file, the system and method of the present invention may advantageously include a means for examining the web page content (i.e., files) received from a mobile device in order to determine whether or not all of the files required for printing the web page have been received.

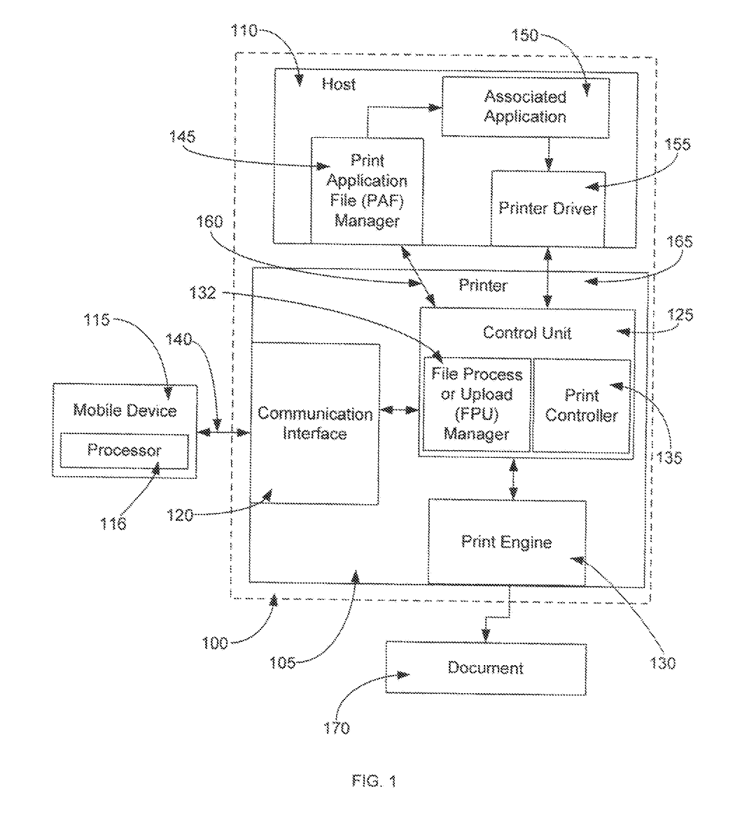

Referring to FIG. 1, there is shown a block diagram of an imaging system 100, according to an illustrative embodiment of the invention. The imaging system 100 may include a printer 105 and a host 110. The printer 105 may be in communication with the host 110 via one or more appropriate communications links, as will be understood by those of ordinary skill in the art. For example, the one or more communications links may be established by a direct cable connection, by a wireless connection, and/or by a network connection such as, for example, an Ethernet local area network (LAN). The printer 105 may also be in communication with a mobile device 115 via one or more appropriate communications links, as will, be explained in greater detail below. It will be understood that the printer 105 may be any device capable of producing a hard copy of a data file or document stored in an electronic form such as, for example, a stand alone printer or a printer that is incorporated into a multifunction machine that includes standalone copying and facsimile capabilities, in addition to optionally serving as a printer.

The host 110 may be any suitable device for processing web page data for printing by the printer 105. For example, the host 110 may be a personal computer. Additionally, the host 110 may include one or more input/output (I/O) devices, such as a keyboard and/or a display monitor. The host 110 may further include one or more processors, one or more input/output (I/O) interfaces, at least one memory such as, for example, RAM, ROM, NVRAM, and at least one mass data storage device such as, for example, a hard drive, CD-ROM and/or DVD units. One or more software applications may be stored in the memory of the host 110, and each software application may be executed according to programmed logic associated with the software application.

With reference back to FIG. 1, the printer 105 may include a communications interface 120, a control unit 125, and a print engine 130. Additionally, the control unit 125 of the printer 105 may include a file process or upload (FPU) manager 132 and a print controller 135. It will be understood that the file FPU manager 132 and the print controller 135 may be software applications that are stored in memory associated with the control unit 125 and executed by the control unit 125 in accordance with programmed logic associated with the software application.

The communications interface 120 of the printer 105 may allow the printer 105 to be in communication with one or more mobile devices. As shown in FIG. 1, a mobile device 115 may be communicatively coupled to the communication interface 120 of the printer 105 via a mobile device communication link 120. The mobile device 115 may be any mobile device such as, for example, a mobile telephone (e.g., a cell phone), a smart phone, a handheld computer, a personal digital assistant (PDA), a notebook computer, or remote processing device. Additionally, the mobile device 115 may include at least one control unit such as, for example, a processor 116, that controls the operation of the mobile device.

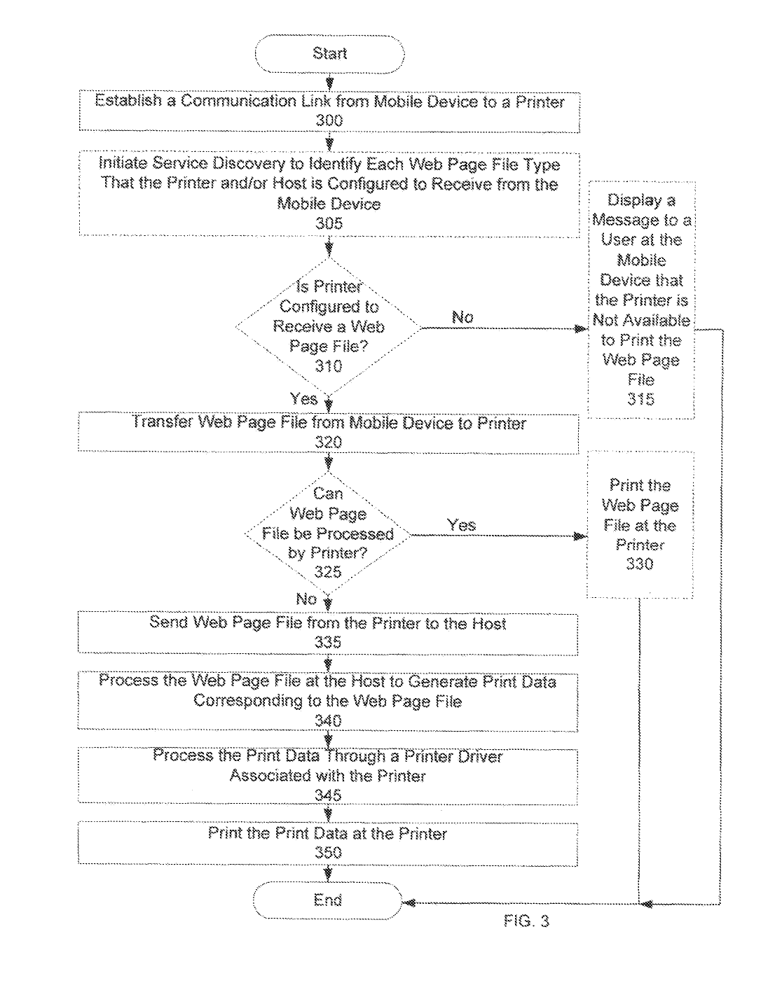

The communications interface 120 may be configured to accommodate either or both of wired or wireless communication with a mobile device 115 via the mobile device communication link 120. For example, the mobile device communication link 120 may be a wireless or wired connection such as, for example, any of a variety of standard connections including: Bluetooth, 802.11x, infrared, wireless Ethernet, ultra-wideband, USB cable, IEEE 1394 (e.g., Firewire), wired Ethernet, memory card, and others. It will be understood that appropriate communication protocols including, but not limited to BPP, SPP, OBEX, Pictbridge, DPOF, IrDA, UPnP, and Web Services may exist for these connections. These appropriate communication protocols may allow service discovery and file exchange between a mobile device 115 and the primer 105, as explained in greater detail below with reference to FIG. 3.

The file process and upload (FPU) manager 132 may receive one or more files associated with a web page from a mobile device 115 via the communication interface 120. The FPU manager 132 may upload the one or more files to a print application file (PAF) manager 145 at the host 110 for processing and printing by the host 110, as explained in greater detail below. The FPU manager 132 may optionally make a determination as to whether or not the printer 105 is capable of locally printing the web page associated with the one or more files. The determination as to whether or not the printer 105 is capable of locally printing the web page may be based at least in part on the content and/or style of the web page. If the printer 105 is capable of locally printing the web page, then the FPU manager 132 or another appropriate software application may direct the print engine 130 of the printer 105 to print the web page. If, however, the printer 105 is not capable of locally printing the web page associated with the one or more files, then the FPU manager 132 may upload the one or more files to the PAF manager 145 at the host 110 for processing. It will be understood that it is generally desirable to process the one or more files for printing at the host 110, thereby simplifying the functionality and processing that needs to be performed by the printer 105. Accordingly, a utilized printer 105 may be a less complex and, therefore, less expensive device.

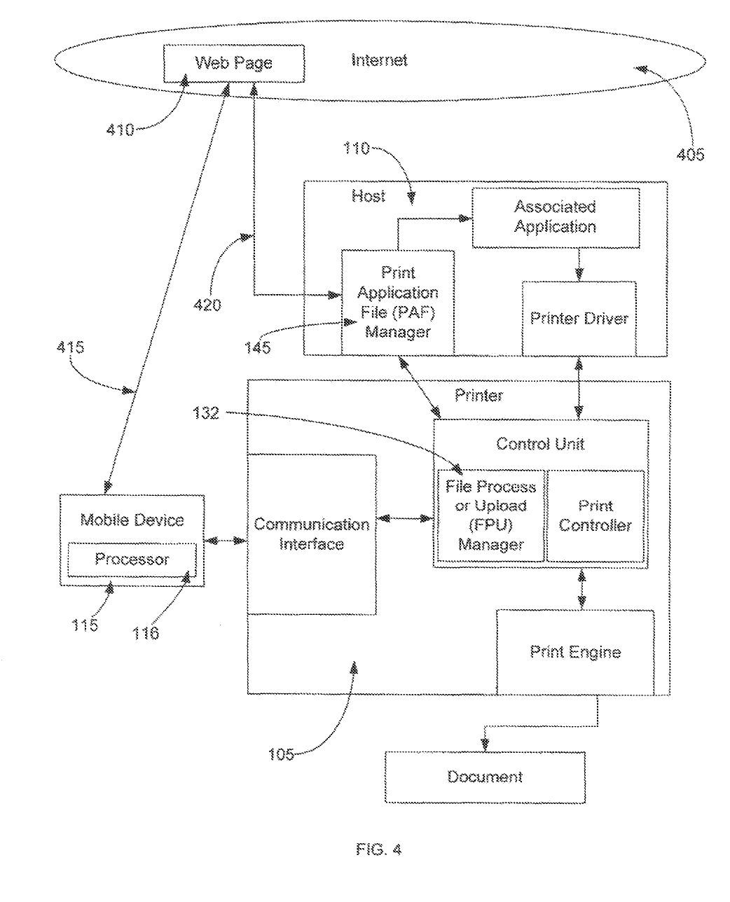

According to an aspect of the invention, the FPU manager 132 may also identify one or more additional files that are desirable or necessary for creating a printed output of the web page to be printed. Alternatively, it will be appreciated that the identification of the one or more additional files may be conducted by the host 110. Whether determined by the host 110 or the FPU manager 132, the FPU manager 132 may request the one or more additional files from the mobile device 115. The mobile device 115 may then transfer the one or more additional files to the FPU manager 132 via the communication interface 120. Prior to transferring or communicating the one or more additional files to the FPU manager 132, the one or more additional files may be stored in a memory associated with the mobile device 115. Alternatively, the mobile device 115 may locate and obtain the one or more additional files in response to the request received from the FPU manager 132. The mobile device 115 may obtain the one or more additional files by downloading, the one or more additional files from a network such as, for example, the Internet. It will be appreciated that the one or more additional files may alternatively be located and obtained by the host 110, as explained in greater detail below with reference to FIG. 4.

Following the transfer or communication of the one or more files associated with a web page from the FPU manager 132 to the host 110, the host 110 may process the one or more files for printing in order to generate print data associated with the web page. The host 110 may transfer or communicate the print data to the printer 105 for printing. The print controller 135 may be an appropriate software application that is configured to receive print data from the host 110 and to output printed pages through the print engine 130.

The print engine 130 may include or incorporate appropriate print process hardware associated with the printer 105 that is configured to output printed pages from the printer 105. The print engine 130 may be, for example, an ink jet print engine configured for forming an image on a sheet of print media, such as a sheet of paper, transparency or fabric. The print engine 130 may include, for example, a reciprocating printhead carrier that is mechanically and electrically configured to mount and carry at least one micro-fluid ejection device (e.g., an ink jet printhead) coupled in fluid communication with an ink source. It will be appreciated that many different types of print engines 130 may be utilized by the printer 105 including, but not limited to, ink jet print engines, dot matrix print engines, and laser print engines.

One or more of the various components of the printer 105 may be in communication with one or more other components of the printer via one or more appropriate communication links, as will be understood by those of ordinary skill in the art. For example, the various components of the printer 105 may be in communication with one another by communications links that are established by using standard electrical cabling or bus structures. As another example, the various components of the printer 105 may be in communication with one another via a wireless connection. It will also be understood that, although the components of the printer 105 are described herein as being separate components, one or more of the various components of the printer 105 may be integrated into one or more other components of the printer 105.

With continued reference to FIG. 1, the host 110 may include a print application file (PAF) manager 145, at least one associated application 150, and at least one printer driver 155. The PAF manager 145 may be an appropriate software application program that is capable of directing the translation of the one or more files associated with a web page to a printable form. In other words, the PAF manager 145 may manage the transfer of the one or more files associated with a web page from the printer 105 to a location in the host 105 where the one or more files may be obtained by the at least one associated application 150 running on host 110, and may initiate the printing process using the associated application 150. The PAF manager 145 may perform the following functions: (a) defining which web page file types that are remotely printable by the host 110 using the at least one associated application 150 installed on the host 110, (b) initiating the printing of the web page delivered to the at least one associated application 150, (c) receiving (or requesting) file data and requests to print web pages from the printer 105, (d) receiving (or requesting) one or more additional files that are needed to print the web page, and/or (e) identifying and obtaining one or more additional files that are needed to print the web page. The functionality and operation of the PAF manager 145 will be described in greater detail below with reference to FIGS. 3 and 4.

The at least one associated application 150 may be a software application(s) that is capable of translating the one or more files associated with a web page into an appropriate format for printing. Once the data has been translated into an appropriate format for printing, it may be referred to as print data. The at least one associated application 150 may be a web browser such as, for example, Internet Explorer, Mozilla Firefox, Safari, Opera, or Netscape. In order to translate the one or more files into print data, the at least one associated application 150 may execute the one or more files in order to reassemble the web page that is to be printed. Once the web page has been reassembled, the at least one associated application 150 may direct the printing of the web page through an appropriate print function or print command associated with the at least one associated application 150. It will be appreciated that the host 110 may include more than one associated application 150. It will further be appreciated that, if the host 110 includes more than one associated application 150, an appropriate associated application may be selected for translating the one or more files associated with a web page into print data. The selection of an appropriate associated application 150 may be made by a variety of components of the imaging system 100 such as, for example, by the PAF manager 145. It will further be appreciated that a default associated application may be established and that the default associated application will be utilized by the host 110 unless the default associated application is incapable of translating the one or more files into an appropriate format for printing.

According to some embodiments of the invention, the associated application 150 may be a web browser that is installed on the host 110 at the same time that the printer driver 155 is installed on the host 110. Accordingly, the web browser may be preconfigured to operate in conjunction with the printer driver 155. According to other embodiments of the invention, the associated application 150 may be a custom browser that is installed on the host 110 by the printer 105 or by software associated with the printer 105. The custom browser may include web printing utilities that provide special functionality to a user when printing. For example, the custom browser may include a utility that allows the removal of content such as, for example, pop-up ads from a web page prior to printing the web page. It will be appreciated that these web printing utilities may also be included in other web browsers and are not limited to custom browsers.

The printer driver 155 may be a software application that is configured to convert data to be printed into a form specific to the printer 105. It will be understood that a printer driver 155 may be incorporated into the host 110 or, alternatively, a printer driver 155 may be incorporated, in whole or in part, in the printer 105. It will be understood that, in some embodiments, the at least one associated application 150 on the host 110 may include the printer driver 155. The printer driver 155 may facilitate communication between the printer 105 and the host 110, and may provide formatted print data to the printer 110 for printing with the print engine 130. It will be appreciated that the print driver 155 may be specific to the printer 105 or, alternatively, the print driver 155 may be capable of facilitating communication between the host 110 and a variety of different printers or types of printers. In operation, the printer driver 155 may process the print data that is generated by the at least one associated application 150 and direct the printer 105 to print the print data.

As shown in FIG. 1, each of the various components of the host 110 is a software application stored at and running on the host 110. Accordingly, one or more of the various components of the host 110 may be in communication with one or more other components of the host 110 via an appropriate software application running on the host 110 that facilitates data transfer between the various components such as, for example, an operating system. However if one or more of the various components of the host 110 are implemented as separate hardware devices, it will be appreciated that one or more of the various components of the host 110 may be in communication with one or more other components of the host 110 via one or more appropriate communication links, as described above with respect to the printer 105.

According to an aspect of the invention, the host 110 may be in communication with the printer 105 via one or more appropriate communication links 160, 165. It will be understood that the one or more communication links 160, 165 may be any appropriate communication links such as, for example, wireless or wired connections between the printer 105 and the host 110 that utilize any of a variety of standard connections including: Bluetooth, 802.11x, infrared, wireless Ethernet, ultra-wideband, USB cable, IEEE 1394 (e.g., Firewire), wired Ethernet, serial cable, and others. As shown in FIG. 1, a first communication link 160 may facilitate communication between the control unit 125 of the printer 105 and the PAF manager 145 of the host 105 and a second communication link 165 may facilitate communication between the control unit 125 of the printer 105 and the printer driver 155, which is depicted in FIG. 1 as being incorporating into the host 110. It will be appreciated, however, that a single communication link such as, for example, a single wired Ethernet connection, may facilitate all of the communication between the printer 105 and the host 110. It will further be appreciated that there may be instances where the mobile device communication link 120 may be of the same form and substance as the one or more communication links 160, 165 (e.g. a 802.11X wireless connection). Such a situation might occur, for example, when the printer 105, the host 110, and the mobile device 115 all utilize the same network communication method.

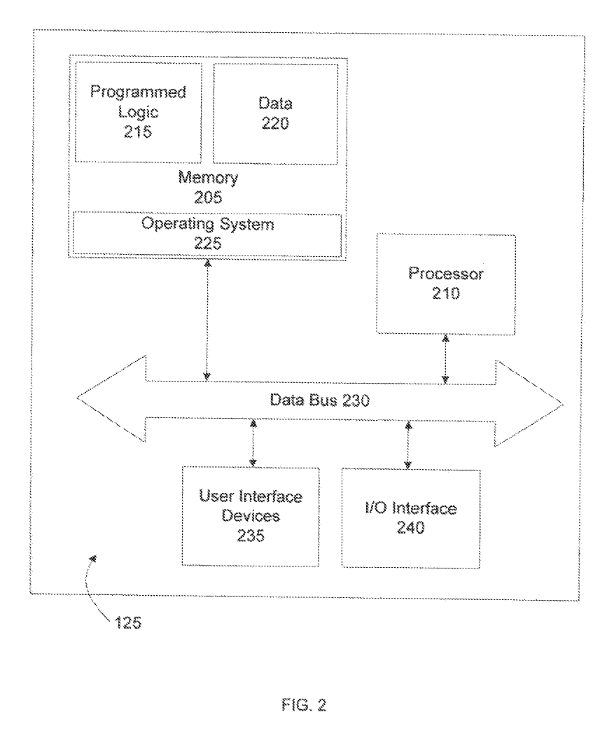

According to an aspect of the invention, the control unit 125 may control the operation of the printer 105. FIG. 2 is a block diagram of the control unit 125, according to an illustrative embodiment of the invention. The control unit 125 may include a memory 205 that stores programmed logic 215 (e.g., software) in accordance with the present invention and a processor 210. The memory 205 may also include date 220 utilized in the operation of the present invention and an operating system 225. The data 220 may include information communicated to the control unit 125 by a mobile device 115 and/or the host 110. The processor 210 may utilize the operating system 225 to execute the programmed logic 215, and in doing so, may also utilize at least a portion of the data 220. A data bus 230 may provide communication between the memory 205 and the processor 210. Users may interface with the control unit 125 via a user interface device(s) 235 such as, for example, a control panel associated with the printer 105, or any other device(s) capable of communicating digital data to the control unit 125. The control unit 125 may be in communication with a mobile device 115, the host 110, and perhaps other external devices, via an I/O Interface 240. In the illustrated embodiment, the control unit 125 is integrated into the printer 105, though it will be understood that the control unit 125 may not be integrated into the printer 105 and may even be located remotely to the printer 105. Further the control unit 125 and the programmed logic 215 implemented thereby may include software, hardware, firmware or any combination thereof. For example, the control unit 125 may be formed as an Application Specific Integrated Circuit (ASIC).

It will be understood by those of skill in the art that the host 110 and/or the mobile device 115 may include or incorporate one or more control units that functions in a similar manner to the control unit 125 of the printer 105. It will be appreciated that the one or more control units of the host 110 and/or the mobile device 115 may be more or less complex than the control unit 125 of the printer 105. For example, as set forth above, the control unit of the host 110 may be a control unit associated with a personal computer.

FIG. 3 is an exemplary flowchart of a method for performing host-assisted web page printing from a mobile device 115, according to an illustrative embodiment of the invention. The method of FIG. 3 may be initiated by a user of mobile device 115, and the mobile device 115 may control printing from the mobile device 115 while the printer 105 and the host 110 function as clients that provide a printing service for the mobile device 115.

With reference to FIG. 3, at step 300, a communication link may be established between a mobile device 115 and the printer 105. According to an aspect of the invention, the established communication link may be a direct communication link. As used herein, the term “direct communication link” refers to a communication link established between, for example, a mobile device 115 and the printer 105, without any intermediary external processing configured to transfer files from the mobile device 115 to the printer 105. For example, a direct communication link may be any appropriate wireless connection that utilizes a wireless communication standard. As another example, a direct communication link may be any appropriate wired connection that utilizes a wired communication standard.

Following the establishment of the communication link at step 300, a service discovery may be initiated by the mobile device 115 at step 305. The service discovery may be initiated by the mobile device 115 to identify each web page file type that the printer 105 and/or the host 110 is configured to receive from any mobile device. For example, the mobile device 115 may issue a request to the printer 105 for the printer 105 to provide a list of web page file types that are supported by the printer 105 in conjunction with the host 110. The FPU manager 132 of the printer 105 may return a list of web page file types that are supported by the printer 105 to the mobile device 115 in response to the request. This list may include the web page file types that the printer 105 is configured to print locally. The printer 105 may additionally or alternatively initiate a service discovery with the host 110 to identify each web page file type that that the host 110 is configured to receive and process for printing. For example, the FPU manager 132 of the printer 105 may issue a request to the PAF manager 145 of the host 110 to provide a list of web page file types that are supported by the host 110. The PAF manager 145 may examine the host system and determine what associated applications are installed on or incorporated into the host system that will permit reception of web page print requests. The PAF manager 145 may determine what web page file types are supported by each of the at least one associated applications 150. A list containing a portion or all of the web page file types supported by the host 110 may be returned to the printer 105 by the PAF manager 145. It will be appreciated that a list containing a portion or all of the web page file types supported by the host 110 may be transferred to the printer 105 without receiving a request for the information from the printer 105. For example, the list may be transferred from the host 105 to the printer 110 as soon as both the host 110 and the printer 105 are powered on or as soon as a communication link is established between the printer 105 and the host 110. The FPU manager 132 of the printer 105 may then communicate a list containing a portion or all of web page file types supported by the host 110 to the mobile device 115. It will be understood that the list of web page file types supported by the host 110 may be combined with the list of web page file types supported for local printing by the printer 105 in order to generate a composite list of supported web page file types. The composite list may be communicated to the mobile device 115 by the printer 105 as part of a service discovery initiated by the mobile device 115.

A web page file type may be any file type associated with one or more web page files. For example, a web page file type may be one of the many versions of HyperText Markup Language (HTML) or one of the many versions of Extensible HyperText Markup Language (XHTML). As previously mentioned, the at least one associated application 150 may be a web browser that is utilized to translate one or more files of a web page file type into an appropriate format for printing.

At step 310, it may be determined whether the printer 105 is configured to receive a web page file type available from the mobile device 115. For example, a list of web page file types that are supported by the printer 105 may be supplied by a file process in the control unit 125 of the printer 105 and may, in turn, be delivered to the mobile device 115. Alternatively, a message may be communicated from the printer 105 to the mobile device 115 that indicates whether the printer 105 is configured to receive one or more files associated with a web page from the mobile device 115 for print processing. Accordingly, it will be appreciated that the determination as to whether the printer 105 is configured to receive a web page file type may be made by the printer 105 and/or the mobile device 115.

If it is determined at step 310 that the printer is not configured to receive a web page file type available from the mobile device 115, then the method or process may proceed to step 315. At step 315, a message to a user may be generated and displayed at the mobile device 115 to indicate to the user that the printer 105 is not available to print the web page. This user message may additionally or alternatively be displayed by the printer 105. If however, it is determined at step 310 that the printer is configured to receive a web page file type available from the mobile device 115, then the method or process may proceed to step 320.

It will be understood that steps 305 and 310 may be optional. As an alternative to performing service discovery, the mobile device 115 may assume that the printer 105 is configured to accept one or more files associated with a web page for print processing. If, however, the printer 105 is not so configured, then step 315 may be invoked. It will further be understood that the printing of a web page is not restricted or limited to mobile devices and/or communications protocols that support a service discovery process. Instead, the printing of a web page may be initiated as long as a mechanism or technique is available to return an error message or other error information to a user if the printer 105 does not support printing of the web page. In such a situation, the printer 105 may be configured to communicate a non supported error message to a user either at the printer 105 or by communicating the error message to the mobile device 115 for display to the user. Additionally, although each of the one or more files associated with a web page may be formatted according to a particular web page file type, it will be understood that the one or more files need not necessarily be formatted according to the same web page file type.

At step 320, one or more files associated with a web page may be transferred or communicated from the mobile device 115 to the printer 105. According to an aspect of the present invention, the mobile device 115 may initiate the printing of the web page. Initiation of the printing of the web page may be accomplished by the mobile device 115 transferring the one or more files to the printer 105 for printing. Alternatively, initiation of the printing may be accomplished by the mobile device 115 initiating a service discovery process. The printing may be initiated by a user of the mobile device 115 inputting an appropriate command into the mobile device. For example, the user of the mobile device 115 may select a web page for printing and the mobile device 115 may transmit a print request to printer 105 through the communication method established. This print request may include one or more files associated with a web page to be printed directly, or may include a referenced location on mobile device 115 at which the one or more files are stored. The print request may optionally include additional information to permit specification of print settings.

The control unit 125 of the printer 105 may also include a memory 205 where the one or more files that are received from mobile device 115 may be saved until the one or more files have been formatted for printing. If the one or more files are transferred or sent from the printer 105 to the host 110 for processing, the one or more files may be stored by the control unit 125 of the printer until the print application file (PAF) manager 145 running on the host 110 is ready to retrieve them from the storage, or the files may be uploaded from the control unit 125 to the host 110 at a later time.

Once the one or more files or a reference location on the mobile device 115 have been transferred to the printer 115, the method or process may go to step 325. At step 325, it may be determined whether the printer 105 is configured to locally process the one or more files for printing. The determination as to whether the printer 105 is configured to locally process the one or more files for printing may be based at least in part on the content and/or style of the web page. If it is determined at step 325 that the printer 105 is capable of locally printing the web page, then the method or process may go to step 330 and the FPU manager 132 or another appropriate software application may direct the print engine 130 of the printer 105 to print the web page. If, however, it is determined at step 325 that the printer 105 is not capable of locally processing the one or more files for printing, then the method or process may go to step 335.

At step 335, the one or more files associated with the web page may be transmitted or communicated from the printer 105 to the host 110. According to an aspect of the invention, the FPU manager 132 of the printer 105 may upload the one or more files to the PAF manager 145 of the host 110 for processing by the host. Once the one or more files have been transmitted to the host 110, the method or process may go to step 340.

At step 340, the one or more files associated with the web page may be processed by an associated application 150 running on the host 110 to generate print data corresponding to the web page. For example, an associated application 158 such as, for example, a web browser, may receive the one or more files from either the PAF Manager 145 or the printer 105, the associated application 150 may translate the one or more files into print data. The print data may be in an appropriate format for printing by the printer 105. In translating the one or more files into print data, the associated application 150 may execute the one or more files in order to reassemble the web page that is to be printed. Once the web page has been reassembled, the at least one associated application 150 may direct the printing of the web page through an appropriate print function or print command associated with the at least one associated application 150. It will be appreciated that more than one associated application 150 may be utilized to process the one or more files associated with the web page.

At step 345, the print data may be processed through a printer driver 155 associated with the printer 105. The printer driver 155 may be a software application that is configured to convert data to be printed into a form specific to the printer 105. It will be appreciated that the printer driver 155 may reside on the host 110 or on the printer 105. It will further be appreciated that portions of or all of the printer driver 155 may reside on both the host 110 and on the printer 105.

At step 350, the print data may be printed at the printer 105. For example, the associated application 150 running on the host 110 may invoke the print controller 135 and the print engine 130 through the printer driver 155. The print controller 135 may receive the print data from the host 110 and output printed pages through the print engine 130. The printed pages may be a hard copy of the web page that a user of the mobile device 115 desires to be printed.

It will be appreciated that the steps described and shown in FIG. 3 may be carried out or performed in any suitable order. It will also be appreciated that not all of the steps described in FIG. 3 need to be performed in accordance with the this embodiment of the invention and/or that additional steps may be performed in accordance with other embodiments of the invention.

According to an aspect of the invention, the processes of steps 335 through 350 may run in the background of the host 110. In other words, the process or method may operate without a user of the mobile device 115 being informed of the processing steps performed by the host 110. For example, no information relating to the printing process may be displayed on the monitor of the host 110. Although the web page may be printed utilizing a host-assisted system or method, it may appear to a user of the mobile device 115 that the web page is being printed directly from the mobile device 115.

FIG. 4 is a block diagram of a second illustrative embodiment of an imaging system 100 embodying the invention. FIG. 4 is an illustrative example of a system that may obtain one or more additional files that are desirable for printing a web page. It will be appreciated that a web page may consists of the web page itself and one or more other files that are referenced by the web page. Once one or more web page files have been transferred to or identified by a printer 105 in communication with a mobile device 115, a determination may be made as to whether one or more additional files are desirable for printing the web page. As explained in greater detail above with reference to FIG. 1, the FPU manager 132 may identify one or more additional files that are desirable or necessary for creating a printed output of the web page to be printed. Alternatively, the identification of the one or more additional files may be conducted by the host 110. Whether determined by the host 110 or the FPU manager 132, the FPU manager 132 may request the one or more additional files from the mobile device 115. The mobile device 115 may then transfer the one or more additional files or a reference location for the one or more additional files to the FPU manager 132 via the communication interface 120. The mobile device 115 may locate and obtain the one or more additional files in response to the request received from the FPU manager 132. The mobile device 115 may obtain the one or more additional files by downloading the one or more additional files from a network such as, for example, the Internet. As shown in FIG. 4, the mobile device 115 may be connected to the Internet 405 (or other network) and, therefore, may be able to access the desired web page 410 for printing. Once the desired web page 410 has been accessed by the mobile device 115, the one or more additional files may be downloaded or obtained by the mobile device 115. The mobile device 115 may be connected to the Internet 405 via an appropriate mobile device communication link 415. The mobile device communication link 415 may be any appropriate communication link for accessing data from a network such as, for example, a connection via a cellular network, a Bluetooth connection, an 802.11x connection, an infrared connection, a wireless Ethernet connection, an ultra-wideband connection, a USB connection, a Firewire connection, a wired Ethernet connection, or another wired or wireless communication links.

It will be appreciated that the one or more additional files may alternatively be located and obtained by the host 110 rather than by the mobile device 115. As shown in FIG. 4, the host 110 may be connected to the Internet 405 and the PAF manager 145 of the host 110 may be capable of accessing the desired web page 410. The host 110 may be capable of accessing the desired web page 410 to obtain the one or more additional files if the host 110 is aware of the Internet Universal Remote Locator (URL) address of the desired web page 410. The URL address may be provided to the host 110 by the mobile device 115 through the printer 105 as part of the print request received from the mobile device 115. Alternatively, the URL address may be extracted from the one or more files provided to the PAF manager 145 or otherwise determined by the host 110. The host 110 may be connected to the Internet 405 via an appropriate host communication link 420. The host communication link 420 may be any appropriate communication link for accessing data from a network such as, for example, a connection via a cellular network, a Bluetooth connection, an 802.11x connection, an infrared connection, a wireless Ethernet connection, an ultra-wideband connection, a USB connection, a Firewire connection, a wired Ethernet connection, or another wired or wireless communication links.

As an example, the mobile device 115 may deliver an XHTML-print file to the printer 105 for printing that contains additional file references. An XHTML-print file may be a web page file that has been designed to be appropriate for printing from a mobile device 115 utilizing a low-cost printer that may not have a full-page buffer. Typically, these low-cost printers print from top-to-bottom and left-to-right with the paper in a portrait orientation. An XHTML-print file may also be targeted for printing in an environment where it may not be feasible or desirable to install a printer-specific driver and where some variability in the formatting of the output is acceptable. Once the XHTML-print file has been received by the printer 105 and later the host 110, the printer 105 and/or the host 110 may request the additional files that are referenced by the XHTML-print file. The request may be communicated to the mobile device 115 by the printer 105 and the additional files may be obtained from the mobile device 115. Alternatively, the XHTML-print file may include the URL address of the desired web page for printing. The host 110 may access this web page and obtain the additional files that are referenced by the XHTML-print file.

It will be understood that, if the printer 105 includes a connection to the Internet 405, then the one or more additional files may alternatively be located and obtained by the printer 105 in a similar manner to that utilized by the host 110.

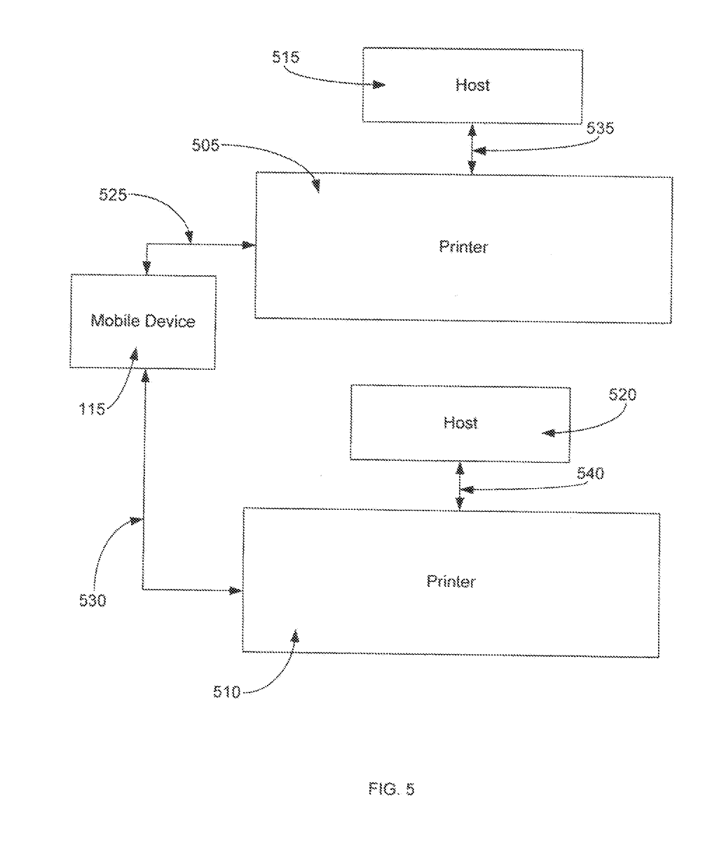

FIG. 5 is a block diagram of a third illustrative embodiment of an imaging system embodying the invention. The imaging system of FIG. 5 may be similar to the imaging system 100 described above with reference to FIG. 1. However, the imaging system of FIG. 5 may include more than one printer and more than one host. With reference to FIG. 5, the mobile device 115 may be in communication with both a first printer 505 and a second printer 510. Additionally, the first printer 505 may be in communication with a first host 515, and the second printer 510 may be in communication with a second host 520. The mobile device 115 may be in communication with the first printer 505 via a first printer communication link 525, and the mobile device 115 may be in connection with the second printer 510 via a second printer communication link 530. Additionally, the first printer 505 may be in communication with the first host 515 via a first host communication link 535, and the second printer 510 may be in communication with the second host 520 via a second host communication link 540. It will be appreciated that the communication links that are utilized may be similar to those described above with reference to FIG. 1. It will further be appreciated that the mobile device 115 may be in communication with any number of printers and that each of these printers may be in communication with at least one host. Additionally, it will be understood that more than one printer may be in communication with the same host.

The first host 515 and the second host 520 may operate in a similar manner, as explained above with reference to FIGS. 1 and 4. However, the first host 515 and the second host 520 may not support the printing of the same web page file types. For example, the first host 515 and the second host 520 may include different associated applications that are capable of translating one or more files associated with a web page into a format that is appropriate for printing. For example, the first host 515 may include Internet Explorer as an associated application, and the second host 520 may include Mozilla Firefox as an associated application. Each of these web browsers may be capable of processing different web pages for printing.

According to an aspect of the invention, the mobile device 115 may determine which connected printer is capable of processing a particular web page for printing. In turn, each connected printer may determine whether or not its connected host is capable of processing a particular web page for printing. This determination may be conducted by a service discovery method initiated by the mobile device 115 with each printer, as discussed above with reference to FIG. 1. Once the mobile device 115 has determined which of the connected printers are capable of processing and printing a web page, the mobile device 115 may select a connected printer and request that the selected printer print the web page.

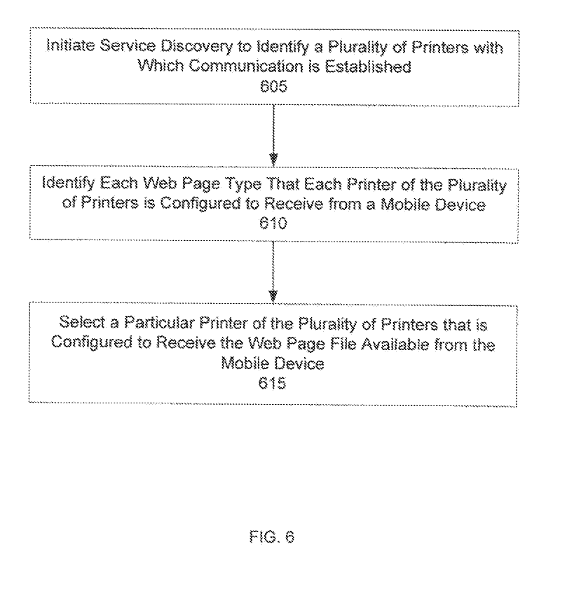

FIG. 6 is an exemplary flowchart of alternative steps for use in conjunction with the method of FIG. 3 in accordance with the embodiment of FIG. 6. Step 305 of FIG. 3 may be modified to include the steps of FIG. 6 and accommodate a scenario in which a mobile device 115 is communicatively linked to multiple printers 505, 510. In such a scenario, all other steps may be performed as described above with reference to FIG. 3, unless otherwise indicated.

With reference to FIG. 6, at step 605, a service discovery may be initiated to identify a plurality of printers, e.g., printers 505, 510, with which communication is established. This service discovery may be initiated by the mobile device 115. At step 610, the service discovery may identify each web page file type that each printer of the plurality of printers 505, 510 is configured to receive from any mobile device.

At step 615, a particular printer of the plurality of printers 505, 510 may be selected that is configured to receive the one or more files associated with the web page that are available from mobile device 115. The particular printer may be selected by the mobile device 115 in light of the conducted service discovery. If the service discovery determines that more than one of the plurality of printers 505, 510 is capable of printing the desired web page, then the mobile device 115 may select a particular printer via any number of appropriate selection and/or preference rules or determinations. For example, one particular printer may be designated as a default printer, and the default printer may be selected by the mobile device 115 if it is capable of printing a desired web page.

Following step 615, the process or method may then proceed to step 310. In this scenario, step 310 may be optional, because the mobile device 115 has already determined that the selected printer is capable of printing the desired web page. Accordingly, the process or method may proceed to step 320 and continue through the remaining steps of FIG. 3. Alternatively, if none of the plurality of printers 505, 510 are capable of processing the desired web page for printing, then the process or method may proceed to step 315.

It will be appreciated that the steps described and shown in FIG. 6 may be carried out or performed in any suitable order. It will also be appreciated that not all of the steps described in FIG. 6 need to be performed in accordance with this embodiment of the invention and/or that additional steps may be performed in accordance with other embodiments of the invention.

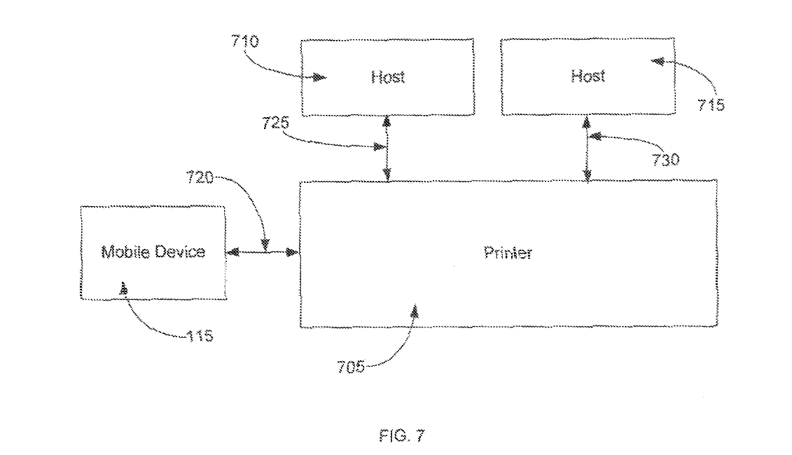

FIG. 7 is a block diagram of a fourth illustrative embodiment of an imaging system embodying the invention. The imaging system of FIG. 7 may be similar to that of FIG. 1; however, the imaging system of FIG. 7 may include a printer 705 that is in communication with more than one host. The printer 705 may be in communication with any number of hosts. As shown in FIG. 7, the printer 705 may be in communication with both a first host 710 and a second host 715. The mobile device 115 may be in communication with the printer 705 via a mobile device communications link 720. Additionally, the printer 705 may be in communication with the first host 710 via a first host communications link 725, and the printer may be in communication with the second host 715 via a second host communications link 730. The various communications links may be any appropriate communications links as explained in detail above with respect to FIG. 1.

According to an aspect of the invention, the mobile device 115 may determine whether the printer 705 is capable of processing a particular web page for printing. In turn, the printer 705 may determine which of a plurality of the connected hosts 710, 715 is capable of processing a particular web page for printing. This determination may be conducted by a service discovery method initiated by the mobile device 115 with the printer 705 and by a service discovery method initiated with each of the plurality of hosts 710, 715 that is initiated by the printer 705, as discussed in greater detail above with reference to FIG. 1. Once the printer 705 has determined which of the connected hosts 710, 715 are capable of processing and printing the web page, if at least one of the connected hosts 710, 715 is capable of printing the web page, then the printer 705 may communicate a message to the mobile device 115 indicating that the web page may be printed by the printer 705.

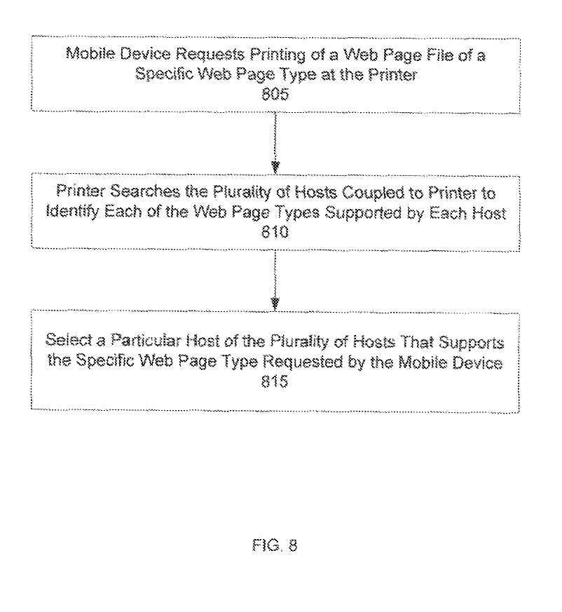

FIG. 8 is an exemplary flowchart of alternative steps for use in conjunction with the method of FIG. 3 in accordance with the embodiment of FIG. 7. Step 305 of FIG. 3 may be modified to include the steps of FIG. 8 and accommodate a scenario in which a mobile device 115 is communicatively linked to at least one printer 705 that is communicatively linked to a plurality of hosts 710, 715. In such a scenario, all other steps may be performed as described above with reference to FIG. 3, unless otherwise indicated.

With reference to FIG. 8, at step 805, the mobile device 115 may request the printing of one or more files associated with a web page at the printer 705. Each of the one or more files may be of a respective web page file type. At step 810, the printer 705 may search the plurality of hosts coupled to the printer 705, e.g., host 710 and host 715, in order to identify each of the web page file types supported by each of the plurality of hosts 710, 715. Within each host 710, 715, there may be a capability to process one or more files associated with a web page of a web page file type as defined by the associated applications that are present in the respective host.

At step 815, a particular host of the plurality of hosts 710, 715 may be selected that is capable of processing the one or more files for printing. Accordingly, the printer 705 may then be configured to receive the one or more files from the mobile device 115 for printing. As an example, the PAF manager within each host 710, 715 may communicate with the printer 705 when selected and may identify or communicate to the primer 705 the supported web page file types. The printer 705 may then select one of the plurality of hosts 710, 715 that supports printing of the one or more files. If multiple hosts are capable of processing the one or more files for printing, then the printer 705 may select a host based at least in part on a variety of selection rules, processes, and/or algorithms. For example, the printer 705 may select the first host determined to support the printing of the web page. As another example, the printer 705 may select the host that includes the fastest processor or the fastest data path. It will be understood that one particular host may be designated as a default host, and the default host may be selected by the printer 705 if it is capable of printing a desired web page.

Following step 815, The process or method may then proceed to step 310 of FIG. 3. In this example, step 310 may be optional, because the mobile device 115 has already determined that the selected printer is capable of printing the desired web page. Accordingly, the process or method may proceed to step 320 and continue through the remaining steps of FIG. 3. Alternatively, if none of the hosts 710, 715 are capable of processing the desired web page for printing, then the process or method may proceed to step 315.

It will be appreciated that the steps described and shown in FIG. 8 may be carried out or performed in any suitable order. It will also be appreciated that not all of the steps described in FIG. 8 need to be performed in accordance with this embodiment of the invention and/or that additional steps may be performed in accordance with other embodiments of the invention.

According to an aspect of the invention, the print request received from the mobile device 115 may also contain information about the print job (such as requested print quality, number of copies, and paper type). The information about the print job may be referred to as print settings. The print settings may be processed along with the one or more files associated with a web page to improve the print results. As an example, print settings might be selected by the user of the mobile device 115 from various options displayed at the mobile device 115 based on the discovery of printer capability when communication is established between mobile device 115 and one or more printers. For example, the user may be informed that a printer is capable of printing a web page in color and may then select an option displayed at the mobile device 115 directing the web page to be printed in color.

According to another aspect of the invention, the web page to be printed may include job control language or page description language that may further define how the web page is to be printed. For example, the web page may include page description language such as, for example, that identified with XHTML-print. Any job control language or page description language may be processed along with the one or more files associated with a web page to improve the print results.

It will be appreciated that embodiments of the invention may provide a system and method that allows relatively low cost and low complexity consumer printers to process instructions to print web pages that are received from mobile devices. Accordingly, the consumer printers may be capable of providing print functionality to mobile devices that is similar to that expected from personal computers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for performing host-assisted web page printing, comprising;
establishing a communication link with a mobile device;
receiving one or more files associated with a web page from the mobile device;
transferring the one or more files to a host, wherein the host processes the one or more files by a print application program running on the host to generate print data corresponding to the web page;
processing the print data through a printer driver; and
printing the print data.

2. The method of claim 1, further comprising:
identifying one or more additional files associated with the web page that are needed to generate the print data, wherein the one or more additional files are processed by the print application program to generate the print data.

3. The method of claim 2, wherein the one or more additional files are identified by the mobile device.

4. The method of claim 2, further comprising:
communicating a request for the one or more additional files to the mobile device; and
receiving the one or more additional files from the mobile device.

5. The method of claim 2, further comprising:
downloading the one or more additional files from a network.

6. The method of claim 1, wherein the communication link established with the mobile device is a wireless connection using a wireless communication standard.

7. The method of claim 1, further comprising:
receiving a request from the mobile device to initiate a service discovery to identify at least one web page file type that is capable of being received from the mobile device and processed for printing.

8. The method of claim 7, further comprising:
initiating a service discovery to identify at least one web page file type that the host is configured to receive and process.

9. The method of claim 7, wherein the one or more files associated with the web page are received from the mobile device after the service discovery identifies the at least one web page file type that is capable of being received from the mobile device and processed for printing;
wherein each of the one or more files is formatted according to a respective identified web page file type.

10. The method of claim 1, further comprising receiving print settings from the mobile device that are used in the creation of printed output.

11. The method of claim 1, wherein the method is initiated by the mobile device, and the method operates without a user of the mobile device being informed of the processing steps performed by the host.

12. The method of claim 1, wherein the host is one of a plurality of hosts and the host is selected based at least in part on the host, having a capability to process the one or more files associated with the web page.

13. A printer configured to perform host-assisted web page printing, comprising:
a communication interface configured (i) to establish a communication link with a mobile device, and (ii) to receive one or more files associated with a web page from the mobile device;
a control unit configured (i) to transfer the one or more files to a host, wherein the host processes the one or more files by a print application program running on the host to generate print data corresponding to the web page and processes the print data through a printer driver associated with the printer; and
a print controller configured to control the printing of the print data though a print engine.

14. A method for performing host-assisted web page printing from a mobile device, comprising:
establishing a communication link with a printer;
transferring one or more files associated with a web page to the printer;
wherein the one or more files are transferred from the printer to a host and the host processes the one or more files by a print application program running on the host to generate print data corresponding to the web page; and
wherein the print data is processed through a printer driver associated with the printer and printed at the printer.

15. The method of claim 14, wherein the one or more files associated with a web page comprises a URL address.

16. The method of claim 15, wherein the host receives the URL address and uses a browser application to retrieve the web page associated with the URL address.

17. The method of claim 16, wherein the host generates print data associated with the retrieved web page and sends the print data to the printer.

18. The method of claim 14, further comprising:
identifying one or more additional files associated with the web page that are needed to generate the print data, wherein the one or more additional files are processed by the print application program to generate the print data.

19. The method of claim 14, further comprising:
receiving a request for one or more additional files associated with the web page that are needed to generate the print data; and
transferring the one or more additional files to the printer.

20. The method of claim 16, wherein the step of establishing a communication link with a printer comprises polling a plurality of printers to identify one or more printers that are capable of printing a particular type of web page file; selecting one of the identified printers having the required capability; and establishing a communication link with the selected printer.
